(19) United States
(12) Patent Application Publication
(10) Pub. No.: US 2010/0229340 A1
(43) Pub. Date: Sep. 16, 2010

(54) Caster

(76) Inventor: Pao-Hsien Cheng, Jen Te Hsiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/382,212

(22) Filed: Mar. 11, 2009

(51) Int. Cl. B60B 33/04

(52) U.S. Cl. 16/45

(57) ABSTRACT

This invention relates to a caster in which a receiving groove is provided internally in the caster base and a pair of opposite holes for pivoting are provided at both sides of the receiving groove. Then, the pivot shaft of the wheel body is fitted into the holes of the receiving groove such that the wheel body can be pivotally fixed in the caster base. In this manner, the assembly of the parts can be conducted easily and conveniently without using any tool. Moreover, the caster has better aesthetic feature in appearance, since the pivot shaft is fitted invisibly in the holes of the receiving groove in the caster base. In application, as the pivot shaft is not exposed to the outside of the caster base, grappling with the other peripheral subject can be prevented.

### BACKGROUND OF THE INVENTION

1. Field of the invention

The present invention relates to a caster, particularly to a caster in which the assembling of its parts becomes easier and more convenient, the aesthetic feature is better, and the grappling with the other peripheral subject can be prevented.

2. Brief Description of the Prior Art

Usually, casters are installed on the bottom of infant playyards, stroller or some sorts of furniture for easier moving. The caster (3) shown in FIG. 6 has a caster base (32) pivotally fixed on the bottom of a leg seat (31), a wheel body (33) being inserted within the caster base (32) and a rivet (34) penetrating through the caster base (32) and the wheel body (33) being riveted to hold the same together so that the wheel body (33) can pivot within the caster base (32). In this manner, infant playyards, stroller or furniture mounted with casters can be moved easily.

The above caster can reach predetermined easy-moving effect for some items, however it has following defects found in practical application.

1). As the caster is assembled by using rivet to hold the caster base and the wheel body in place so that the wheel body can pivot within the caster base, tools should be used in assembling operation. Thus, it will cause inconvenience in assembling.

2). As the caster is assembled by using rivet to hold the caster base and the wheel body in place so that the wheel body can pivot within the caster base, the rivet after riveting is somewhat protruded to the outside of the caster base. The total aesthetic feature of the caster is deteriorated by the exposure and the protruding of the rivet.

3). As the caster is assembled by using rivet to hold the caster base and the wheel body in place, the rivet after riveting is protruded outside at both sides of the caster base so that the other peripheral subject is easily grappled with the exposed rivet and might be damaged very easily.

In view of the above facts, inventor of the present invention provides a new caster according to the improvement conducted on defects of the existing structure based on his abundant experience of R&D and manufacturing in relevant field so as to attain better performance in practical application.

### SUMMARY OF THE INVENTION

According to the caster of the present invention, a receiving groove is provided in the caster base and a pair of opposite holes for pivoting is provided at both sides of the receiving groove. Then, the pivot shaft of wheel body is fitted into the holes of the receiving groove such that the wheel body can be pivotally mounted in the caster base. In this manner, the assembling of the parts can be conducted without using any tool so as to make the assembly become easier and more convenient. Moreover, the caster is more aesthetic in appearance, as the pivot shaft is provided invisibly in the holes for pivoting of the receiving groove in the caster base. In application, as the pivot shaft is not exposed to the outside of the caster base, grappling with the other peripheral subject can be prevented.

### BRIEF DESCRIPTION OF THE DRAWINGS

The present invention will be better understood by referring to the accompanying drawings, wherein:

FIG. 1 is a perspective exploded view showing the caster of the present invention.

FIG. 2 is a perspective assembled view showing the caster of the present invention.

FIG. 3 is a sectional end view showing the caster of the present invention.

FIG. 4 is a perspective exploded view showing the first embodiment of the caster of the present invention.

FIG. 5 is a sectional end view showing another embodiment of the caster of the present invention.

FIG. 6 is a perspective structural view of a conventional caster.

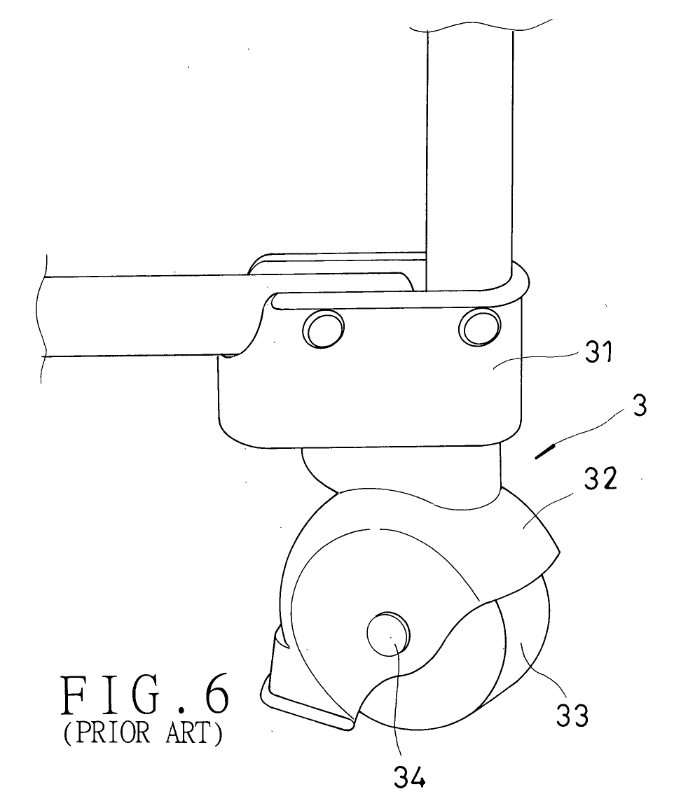

### DETAILED DESCRIPTION OF THE PREFERRED EMBODIMENTS

The objects, the technical contents and the expected effectiveness of the present invention will become more apparent from the detailed description of the preferred embodiment in conjunction with the accompanying drawings.

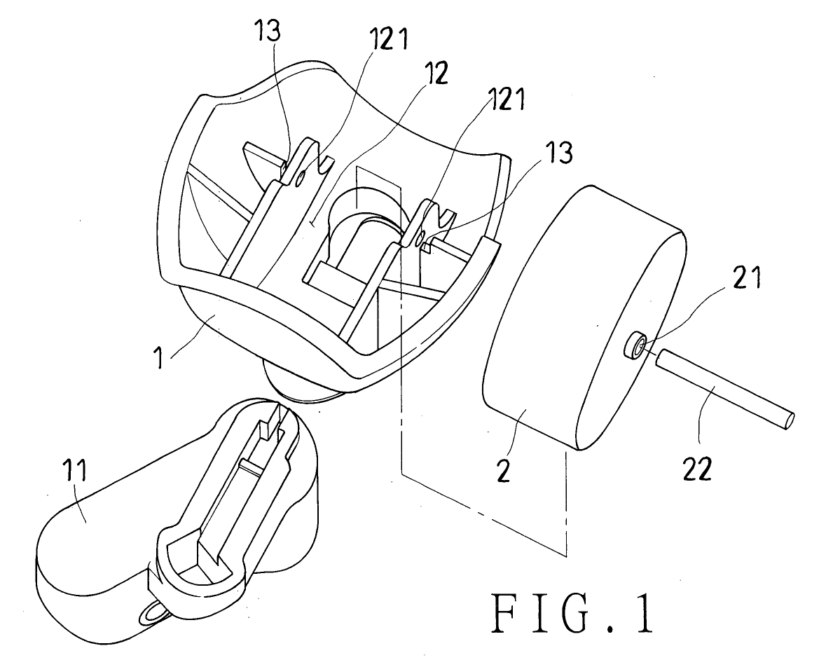

Firstly referring to FIG. 1 showing a perspective exploded view of the present invention, the caster is composed of a caster base (1) and a wheel body (2). A leg seat (11) is provided on the top end of the caster base (1), and a receiving groove (12) is provided in the caster base (1). A pair of opposite holes (121) for pivoting is provided at both sides of the receiving groove (12), and a pair of stop recesses (13) is provided at the outside of the holes (121) for pivoting. The wheel body (2) has a bore (21) passed through its center in which the pivot shaft (22) is inserted.

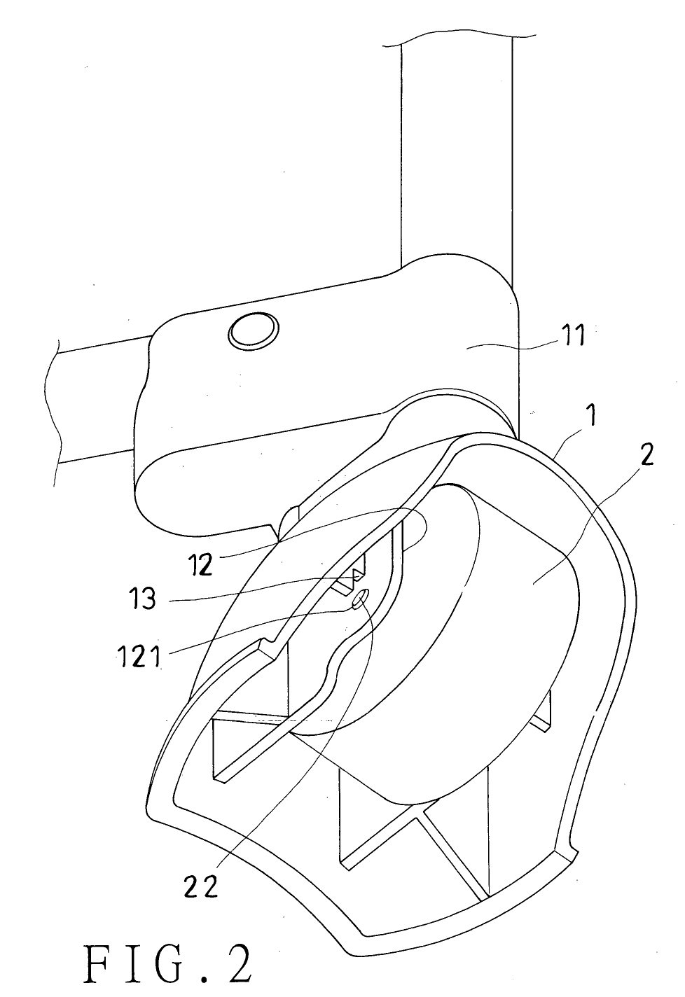

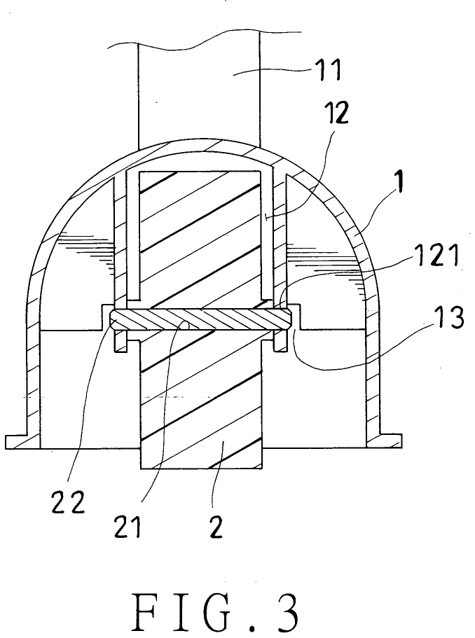

Referring to FIG. 2 showing the perspective assembly view and FIG. 3 showing a sectional end view of the present invention, the pivot shaft (22) is inserted into the bore (21) of the wheel body (2) and the wheel body (2) with the inserted pivot shaft (22) is placed within the receiving groove (12) of the caster base (1). At the same time, both ends of the pivot shaft (22) is inserted through respective holes (121) provided at both sides of the receiving groove (12) and are limited respectively by the stop recesses (13) so as not to be stripped from the holes (121). In this way, the wheel body (2) can be pivotally fitted in the caster base (1) and can be rotated with the pivot shaft (22) as the axis.

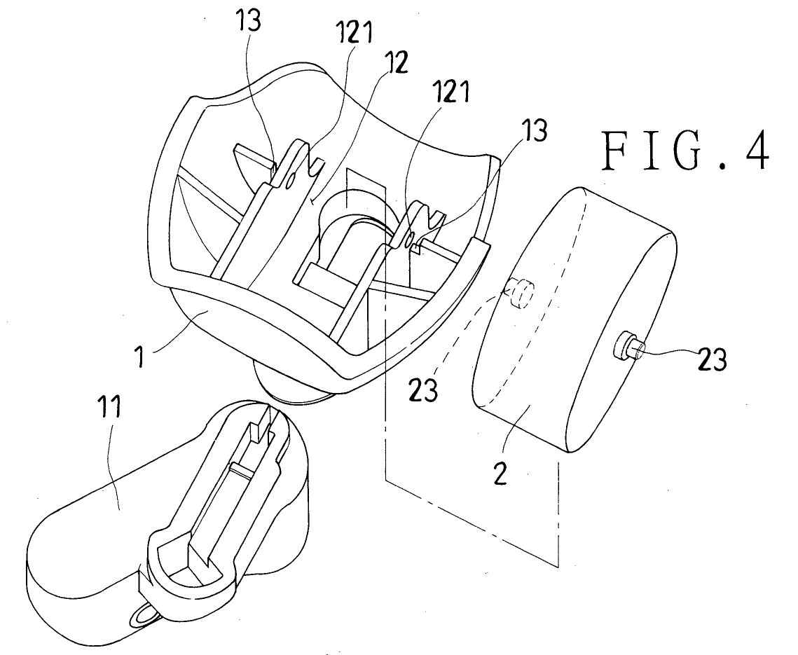

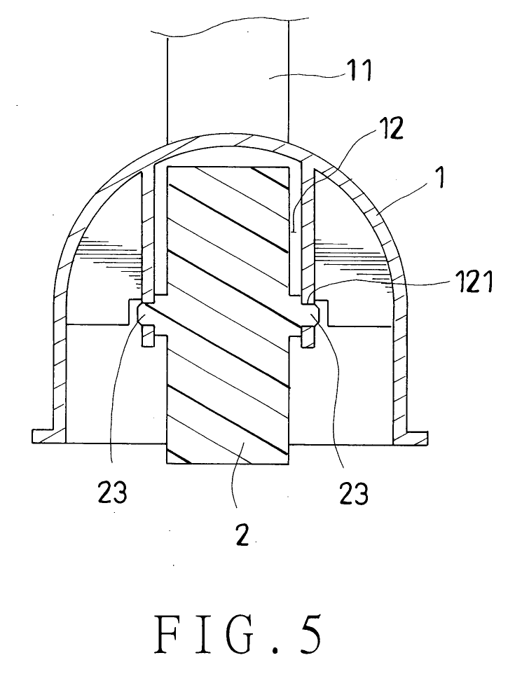

Alternatively, referring to FIG. 4 showing a perspective exploded view of another embodiment of the present invention, instead of providing a bore (21) penetrating at the center of the wheel body (2) for the insertion and combination of the pivot shaft (22) with the wheel body (2) as described in the abovementioned embodiment, a pair of opposite pivot shaft portions (23) is integrally formed in the center positions at both sides of the wheel body (2) so that the wheel body (2) with the integrally formed pivot shaft portions (23) on it is placed into the receiving groove (12) of the caster base (1). The pivot shaft portions (23) are inserted through respective holes (121) provided at both sides of the receiving groove (12) (referring to FIG. 5 showing a sectional end view of another embodiment of the present invention) and are limited respectively by the stop recesses (13) so as not to be stripped from the holes (121). Similarly, the wheel body (2) can be pivotally fitted in the caster base (1) and can be rotated with the pivot shaft portions (23) as the axis.

The abovementioned embodiments and drawings are not used to limit of the scope of the present invention. Equivalent variations and modifications made by the person skilled in the art without departing from the spirit and scope of the present invention are still considered to be within the scope of the present invention.

Based on the foregoing, the caster of the present invention has the following advantages when comparing with the structure of conventional caster.
1. The wheel body with the combined pivot shaft of the present invention is directly placed within the receiving groove of the caster base and both ends of the pivot shaft are respectively fitted into the holes provided at both sides of the receiving groove during assembling. The assembling of parts can be finished easily and conveniently without any assistance of the other tool.
2. Both ends of the pivot shaft of the wheel body are respectively fitted into the holes provided at both sides of the receiving groove during assembling. As the pivot shaft is not exposed or protruded to the outside of the caster base, the caster has better aesthetic feature in total appearance.
3. As both ends of the pivot shaft of the wheel body are respectively fitted into the holes provided at both sides of the receiving groove during assembling the pivot shaft is not exposed or protruded to the outside of the caster base. In application, grappling of the caster with the other peripheral subject thus can be prevented.

Summing up above, the caster of this invention can reach expected effectiveness, and the specific configurations disclosed herein have yet not seen in the prior art of the same category of product, even has not been opened to the public before application.

What is claimed is:

1. A caster, formed by a wheel body combined with a caster base, wherein a receiving groove is provided internally in the upper of the caster base and a pair of opposite holes for pivoting are provided at both sides of the receiving groove, said wheel body being accommodated within said receiving groove and a pivot shaft being provided on said wheel body to fit and pivotally combine with said holes for pivoting.

2. A caster as claimed in claim 1, wherein said caster base has a pair of stop recesses respectively provided at the outsides of the holes for pivoting in the receiving groove.

3. A caster as claimed in claim 1, wherein said wheel body has a bore at the center position for fitting and combining with said pivot shaft.

4. A caster as claimed in claim 1, wherein said wheel body is integrally formed with a pair of opposite pivot shaft portions protruding outward at the center positions on both sides.
